(19) United States
(12) Patent Application Publication
(10) Pub. No.: US 2013/0146225 A1
(43) Pub. Date: Jun. 13, 2013

(54) GAS INJECTOR APPARATUS FOR PLASMA APPLICATOR

(71) Applicants: Xing Chen, Lexington, MA (US); Youfan Gu, Superior, CO (US); Chengxiang Ji, Waltham, MA (US); Paul Ashby Loomis, Georgetown, MA (US); Ilya Pokidov, North Reading, MA (US); Kevin Wayne Wenzel, Belmont, MA (US)

(72) Inventors: Xing Chen, Lexington, MA (US); Youfan Gu, Superior, CO (US); Chengxiang Ji, Waltham, MA (US); Paul Ashby Loomis, Georgetown, MA (US); Ilya Pokidov, North Reading, MA (US); Kevin Wayne Wenzel, Belmont, MA (US)

(73) Assignee: MKS INSTRUMENTS, INC., Andover, MA (US)

(21) Appl. No.: 13/314,347

(22) Filed: Dec. 8, 2011

(51) Int. Cl. B44C 1/22; F16L 9/00

(52) U.S. Cl. 156/345.33; 138/177

(57) ABSTRACT

A plasma chamber for use with a reactive gas source that includes a first conduit comprising a wall, an inlet, an outlet, an inner and outer surface, and a plurality of openings through the wall, the inlet receives a first gas for generating a reactive gas in the first conduit with a plasma formed in the first conduit. The plasma chamber also includes a second conduit that includes a wall, an inlet, and an inner surface. The first conduit is disposed in the second conduit defining a channel between the outer surface of the first conduit and the inner surface of the second conduit. A second gas provided to the inlet of the second conduit flows along the channel and through the plurality of openings of the wall of the first conduit into the first conduit to surround the reactive gas and plasma in the first conduit.

### FIELD OF THE INVENTION

The currently described invention relates to a gas injector apparatus for plasma applicators and methods for injecting gas and generating plasmas.

### BACKGROUND

Plasmas are often used to activate gases placing them in an excited state causing enhanced reactivity. The gases may be excited to produce dissociated gases containing ions, free radicals, atoms and molecules. Excited gases are used for numerous industrial and scientific applications, including processing solid materials such as semiconductor wafers and powders, other gases, and liquids. The parameters of the dissociated gas and conditions under which the dissociated gas interacts with a material to be processed by the system vary widely depending on the application. For example, atomic fluorine is used to etch materials such as Si, SiO₂, W, and TiN. Atomic oxygen is used to remove photoresist or other hydrocarbon materials. Ionic and atomic hydrogen can be used to remove oxides of copper and silicon. The amount of power required in the plasma for dissociation to occur may vary depending on, for example, gas flow rates, gaseous species, plasma chamber pressure, and the specific application for the plasma source.

Plasma sources generate plasmas in various ways. For example, plasma sources generate plasma by applying an electric field in a plasma gas (e.g., O₂, NF₃, Ar, CF₄, H₂, and He) or a mixture of gases. Plasma sources may generate plasma using a DC discharge, microwave discharge, or radio frequency (RF) discharge. A DC discharge generates a plasma by applying a potential between two electrodes in a plasma gas. A microwave discharge generates a plasma by directly coupling microwave energy through a microwave-transparent window into a discharge chamber containing a plasma gas. An RF discharge generates a plasma either by electrostatically or inductively coupling energy from a power supply to the plasma.

Electrostatically coupled plasmas usually having higher ion bombardment energies than inductively coupled plasmas, and are typically used in applications where higher ion energy is preferred, or where higher ion energies do not cause any deleterious effects. Inductively coupled plasmas are used in applications where surface bombardment by high energy ions is not desired or where a high plasma density is needed. Inductive and electrostatic coupling often simultaneously occur in an inductively-coupled plasma device, as there is usually a high electric voltage applied to the induction coil and the coil is in close proximity to the plasma. Electrostatic shields may be used between an induction coil and a plasma to prevent or reduce electrostatic coupling. However, electrostatic shields often reduce coupling efficiency between an induction coil and plasma, causing RF power to be wasted and impedance matching to become more difficult. Plasmas are often contained in vessels that are composed of metallic materials such as aluminum, dielectric materials such as quartz or sapphire, or a combination of metallic and dielectric materials.

In plasmas containing chemically reactive gases, such as fluorine, chlorine, oxygen or hydrogen, the high reactivity of the excited gases often causes chemical erosion of the plasma vessel surface. Various techniques have been developed to minimize surface-plasma interactions by reducing the energy and density of ions at the surfaces of a plasma vessel, selecting chemically stable surface materials, and reducing the temperature of the vessel walls. Due to low operation pressures in most plasma devices, the flow of process gases can push the plasma towards the plasma vessel surfaces. Prior art gas injection methods for plasma sources/applicators are generally inadequate to sufficiently prevent plasma-wall interaction. Some structures (e.g., shower head structures) are used in plasma applicators to manipulate the direction of gas flow into plasma chambers for efficient mixing or to control the uniformity of the plasma, but these structures do not adequately protect the surfaces of the plasma chamber. Magnetic fields are also sometimes used to isolate the plasma from plasma chamber walls to reduce surface erosion by the plasma.

A need therefore exists for improved gas injector apparatus for plasma applicators and methods for injecting gas and generating plasmas.

### SUMMARY

One embodiment of the invention includes a structure of concentric tubes. The outer tube/conduit is solid and provides an outer structure for containing gases or fluids within the structure. The inner tube has a plurality of openings (e.g., slits or holes) that permit gas to pass from the annular volume between the two tubes into the volume of the inner tube. Thermo-mechanical stress on the tubes is reduced by holding the structures firmly only at one end. A first gas is delivered to the inlet of the inner tube for generating a reactive gas by a plasma. A second gas is delivered to the inlet of the outer tube, flowing along a channel between the inner and outer tubes and entering the inner tube through the plurality of openings of the wall of the inner tube. A plasma is generated in the inner tube using a high-frequency power source (e.g., microwave or RF power source) that applies energy to the gas/gases delivered to the inside of the inner tube. The flow of the second gas through the openings of the wall of the inner tube creates a pressure gradient and gas flow that surrounds the plasma (and reactive gases) located within the inner tube. The pressure gradient and the kinetic force of the gas flow push the plasma (and reactive gases) away from the surface of the inner tube, reducing the flux of energetic particles on the inner surface of the inner tube. The pressure gradient and the gas flow also force the neutral gases excited by the plasma away from the inner surface of the inner tube. These reduce surface erosion of the tube and associated chemical or particle contamination.

The invention, in one aspect, features a plasma chamber for use with a reactive gas source. The plasma chamber includes a first conduit comprising a wall, an inlet, an outlet, an inner and outer surface, and a plurality of openings through the wall, the inlet for receiving a first gas for generating a reactive gas in the first conduit with a plasma formed in the first conduit. The plasma chamber also includes a second conduit that includes a wall, an inlet, an outlet, and an inner surface. The first conduit is disposed in the second conduit defining a channel between the outer surface of the first conduit and the inner surface of the second conduit. A second gas provided to the inlet of the second conduit flows along the channel and through the plurality of openings of the wall of the first conduit into the first conduit to surround the reactive gas and plasma in the first conduit. In some embodiments, the first gas and the second gas are different types of gases that flow into the plasma chamber through separate gas inlets. In some embodiments, the first gas and the second gas are the same gas or mixture of gases, and they are split to feed to the inlets of the first and the second conduit in the plasma chamber. In some embodiments the outlet of the second conduit is sealed off, wherein by sealing off the outlet of the second conduit all of the gas provided to the inlet of the second conduit flows through the plurality of openings of the wall of the first conduit into the first conduit.

In some embodiments, the plasma chamber includes a power source for generating the plasma in the first conduit. The power source can operate at radio frequency or microwave frequency to couple electromagnetic power to plasma.

In some embodiments, the first conduit includes a plurality of conduit sections coupled together and the openings are located between the conduit sections where they are coupled together. In some embodiments, the plurality of conduit sections are coupled together with one or more ribs joining the outer surfaces of each conduit section to each other. In some embodiments, one or more ribs define the channel gap between the outer surface of the first conduit and the inner surface of the second conduit. In some embodiments, the openings in the first conduit are passages/passageways through the wall, such as holes, slots, slits or a combination thereof.

In some embodiments, the openings are directed radially inward through the wall of the first conduit. In some embodiments, the passageways of the openings are located at an angle relative to the normal direction of surface of the first conduit to provide a tangential component of gas flow along the surface, either along or at an angle to a longitudinal axis of the first conduit. In some embodiments, the passageways of the openings are directed radially inward through the wall of the first conduit and directed along the first gas flow direction. In some embodiments, the passageways of the openings are directed radially inward through the wall of the first conduit and at an acute angle relative to the direction of the first gas flow to create a helical gas flow along the inner surface of the first conduit.

In some embodiments, the outlet of the first conduit comprises a mounting flange for coupling one common end of the first and second conduits to the reactive gas source, wherein by coupling the one common end of the first and second conduits thermal mechanical stress is minimized in the first and second conduits in operation. In some embodiments, the first and second conduits each comprise a plurality of conduit legs forming a toroidal plasma chamber.

The invention, in another aspect, features a method for generating a reactive gas in a plasma chamber of a reactive gas source. The plasma chamber includes a first conduit that has a wall, an inlet, an outlet, an inner and outer surface, and a plurality of openings through the wall. The plasma chamber also includes a second conduit that has a wall, an inlet, an outlet, and an inner surface. The first conduit is disposed in the second conduit defining a channel between the outer surface of the first conduit and the inner surface of the second conduit. The method includes providing a first gas to the inlet of the first conduit and generating a reactive gas in the first conduit with a plasma formed in the first conduit. The method also includes providing a second gas to the inlet of the second conduit that flows along the channel and through the plurality of openings of the wall of the first conduit into the first conduit to surround the reactive gas and plasma in the first conduit.

In some embodiments, the method includes providing the second gas to the inlet of the second conduit prior to providing the first gas to the inlet of the first conduit. In some embodiments, the method includes varying gas supply properties of the second gas to create a sheath of gas surrounding the plasma and reactive gas formed in the first conduit. In some embodiments, the method includes varying the gas supply properties to cool the wall of the first conduit. In some embodiments, the method includes simultaneously providing the first and second gases to the inlets.

In some embodiments, the method includes igniting the plasma in the first conduit by applying energy to the first gas in the first conduit. In some embodiments, the second gas flows radially inward in the first conduit, and a plasma is ignited in the first conduit by applying energy to the second gas. In some embodiments, the second gas flows partially tangentially and partially radially inward in the first conduit. In some other embodiments, both the first and second gas are flowed into the first conduit. Plasma is ignited in the first conduit by applying energy to the first and second gases in the first conduit. In some embodiments, the method includes monitoring the gas pressures and flow rates in the first conduit and in the channel between the first conduit and the second conduit. In some embodiments, the method includes monitoring the position of the plasma relative to the first conduit and the temperature of the first conduit.

The invention, in another aspect, features a reactive gas source. The reactive gas source includes a plasma chamber that includes a first and second conduit. The first conduit includes a wall, an inlet, an outlet, an inner and outer surface, and a plurality of openings through the wall, the inlet for receiving a first gas for generating a reactive gas in the first conduit with a plasma formed in the first conduit. The second conduit includes a wall, an inlet, an outlet, and an inner surface. The first conduit is disposed in the second conduit defining a channel between the outer surface of the first conduit and the inner surface of the second conduit, wherein a second gas provided to the inlet of the second conduit flows along the channel and through the plurality of openings of the wall of the first conduit into the first conduit to surround the reactive gas and plasma in the first conduit. The reactive gas source also includes a power source for generating the plasma in the first conduit with the first gas and second gas and a gas supply for supplying the first and second gas to the plasma chamber.

The invention, in another aspect, features a conduit for a plasma chamber for use with a reactive gas source. The conduit includes a wall, an inlet, an outlet and an inner and outer surface. The conduit also includes a plurality of openings through the wall, the plurality of openings for receiving a gas to surround a reactive gas and plasma formed in the conduit. In some embodiments, the conduit includes a registration element that registers with a corresponding element on a reactive gas source.

Other aspects and advantages of the current invention will become apparent from the following detailed description, taken in conjunction with the accompanying drawings, illustrating the principles of the invention by way of example only.

### BRIEF DESCRIPTION OF THE DRAWINGS

The foregoing features of various embodiments of the invention will be more readily understood by reference to the following detailed descriptions in the accompanying drawings, in which:

FIG. 1 is a schematic illustration of a plasma chamber of a reactive gas source, according to an illustrative embodiment of the invention.

FIG. 2 is a perspective view of a schematic illustration of a conduit of a plasma chamber, according to an illustrative embodiment of the invention.

FIG. 3A is an end view of a schematic illustration of a conduit of a plasma chamber, according to an illustrative embodiment of the invention.

FIG. 3B is a cross-sectional, side view of the conduit of FIG. 3A.

FIG. 4 is a schematic illustration of a toroidal plasma chamber, according to an illustrative embodiment of the invention.

FIG. 5 is a cross-sectional view of a microwave plasma applicator, according to an illustrative embodiment of the invention.

FIG. 6 is a flowchart of a method for generating a reactive gas in a plasma chamber of a reactive gas source, according to an illustrative embodiment of the invention.

### DETAILED DESCRIPTION OF ILLUSTRATIVE EMBODIMENTS

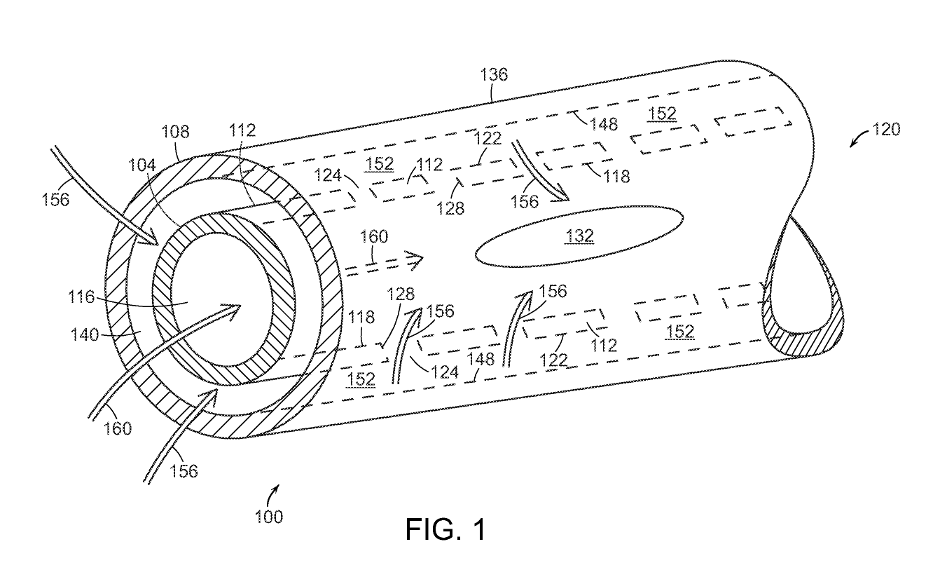

FIG. 1 is a schematic illustration of a plasma chamber 100 of a reactive gas source, according to an illustrative embodiment of the invention. The plasma chamber 100 includes a first conduit 104. The first conduit 104 has a wall 112, an inlet 116, an outlet 120, an inner surface 118, and an outer surface 122. The first conduit 104 also has a plurality of passages 124 through the wall 112 defining a plurality of openings 128 (e.g., slits or holes) through the wall 112. In operation, a first gas 160 is provided to the inlet 116 of the first conduit 104 to generate a reactive gas in the first conduit 104 with a plasma 132 that is formed in the first conduit 104. In this embodiment, the passages 124 of the openings 128 are directed radially inward through the wall 112 of the first conduit 104 and directed along the direction of the flow of the first gas 160. In alternative embodiments, the openings 128 are directed with an acute angle relative to the gas flow direction. In some embodiments, the first conduit 104 and second conduit 108 are fabricated using dielectric materials (e.g., quartz, alumina, sapphire, aluminum nitride, boron nitride, yttria) and a microwave source is used to couple microwave energy into the first conduit 104 to generate the plasma 132 with the first gas 160. Alternative methods and apparatus can be used to generate the plasma 132 in alternative embodiments of the invention. For example, power sources other than microwave sources (e.g., inductively-coupled power sources, RF power sources) can be used to couple energy into the plasma chamber 100 to generate and sustain the plasma 132.

In some embodiments, the first gas is a process gas (e.g., O₂, H₂, N₂, or NF₃) that is flowed into the first conduit 104 and used to generate the plasma 132. In some embodiments, an inert gas (e.g., argon or helium), or a mixture of an inert gas and the process gas, is used during plasma ignition. Lower electric fields are required for exciting inert gases. Because the electric field needed to excite a plasma is typically much higher than the electric field needed to maintain the plasma, an inert gas is sometimes used during ignition to reduce the requirements of the power supply/gas excitation.

In some embodiments, the plasma chamber 100 includes an ignition source (not shown) that generates free charges in the first conduit 104 to assist in the ignition of gas in the first conduit 104. The ignition source that generates free charges in the first conduit 104 can be an electrode positioned in the first conduit 104 or an ultraviolet source optically coupled to the first conduit 104. The ignition source can be located within, or partially within, the first conduit 104. It can also be located outside of the first conduit 104 and the second conduit 108 and be optically coupled to the first conduit 104.

The second conduit 108 has a wall 136, an inlet 140, an outlet (not shown), and inner surface 148. In some embodiments, the when assembled, the outlet of the second conduit is sealed. The outlet The first conduit 104 is disposed in the second conduit 108, defining a channel 152 between the outer surface 122 of the first conduit 104 and the inner surface 148 of the second conduit 108. In operation, a second gas 156 is provided to the inlet 140 of the second conduit 108. The second gas 156 flows along the channel 152 and through the openings 128 of the passages 124 into the first conduit 104. The second gas 156 surrounds the reactive gas and plasma 132 in the first conduit 104.

In operation, properties (e.g., gas flow rate, species mix, pressure) of the second gas 156 are controlled so gas flowing along the channel 152 and then through the openings 128 into the first conduit 104 create a pressure gradient that forces the reactive gas and plasma 132 away from the inner surface 118 of the first conduit 104. The flux of energetic particles on the surfaces (e.g., inner surface 118) of the first conduit 104 are reduced by forcing the reactive gas and plasma 132 away from the inner surface 118 of the first conduit 104. The gas flow and pressure gradient also push the neutral gases excited by the plasma 132 away from the inner surface 118 of the first conduit 104. This reduces surface erosion of the first conduit 104 and the associated chemical or particle contamination that otherwise occurs. The activated gases may contain ions, atoms and molecules of, for example, C, H, O, N, F, Cl, and Br. The gas flowing through the openings 128 of the wall 112 of the first conduit 104 also provides cooling to the wall 112. The wall 112 of the first conduit 104 is cooled because the heat flux from the plasma 132 to the wall 112 is reduced when the plasma 132 is forced away from the inner surface 118 of the wall 112. In addition, the first conduit is also cooled by the heat convection effects associated with the second gas 156 flowing through the openings 128 and along the inner surface 118 and outer surface 122 of the first conduit 104. The second gas 156 can be an inert gas, a process gas, or a mixture of an inert gas and a process gas.

The openings 124 through the wall 112 of the first conduit 104 can be made having a variety of geometries. For example, the openings 124 can have, for example, a circular, oval, square, rectangular or irregular shape. In some embodiments, the openings are holes, slots, slits or a combination thereof. The plane defined by the openings may be parallel to the longitudinal axis of the first conduit or at an angle pointed into the direction of the flow of the first gas 160 or along the direction of flow of the first gas 160. The openings 124 may be at an angle relative to the inner surface 118 of the first conduit 104 to provide a tangential component of gas flow along the surface 118, either along or at an angle to a longitudinal axis of the first conduit 104.

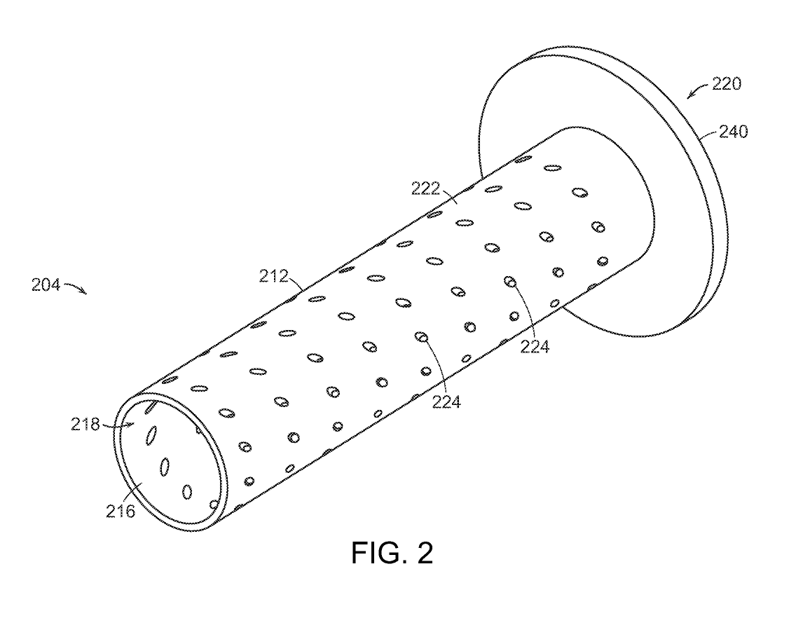

FIG. 2 is a perspective view of a schematic illustration of a conduit 204 of a plasma chamber, according to an illustrative embodiment of the invention. The conduit 204 could be used as the first conduit 104 of FIG. 1. The conduit 204 has a wall 212, an inlet 216, an outlet 220, an inner surface 218, and an outer surface 222. The conduit 204 also has a plurality of passages 224 through the wall 212 defining a plurality of openings 228 (holes) directed radially inward through the wall 212 of the conduit 204, at an angle relative to the longitudinal axis of the conduit 204. In operation, a plasma gas is provided to the inlet 216 of the conduit 204 to generate a reactive gas in the conduit 204 with a plasma that is formed in the conduit 204. The reactive gas is then output from the outlet 220 of the first conduit 204. In operation, a second gas is directed radially inward through the openings 228 from the outer surface 222 to the inner surface 218 (similarly as described herein with respect to, for example, the first conduit 104 of FIG. 1). The openings 228 in the conduit 204 can also be angled to create a helical gas flow along the inner surface 218 of conduit 204. The conduit 204 also includes a mounting flange 240 located at the outlet 220 of the conduit 204. Alternatively, the mounting flange 240 can be located at inlet 216 of the conduit 204. The plasma source with which the conduit 204 would be used includes a complementary flange coupling mechanism that couples the conduit 204 to the plasma source via the mounting flange 240.

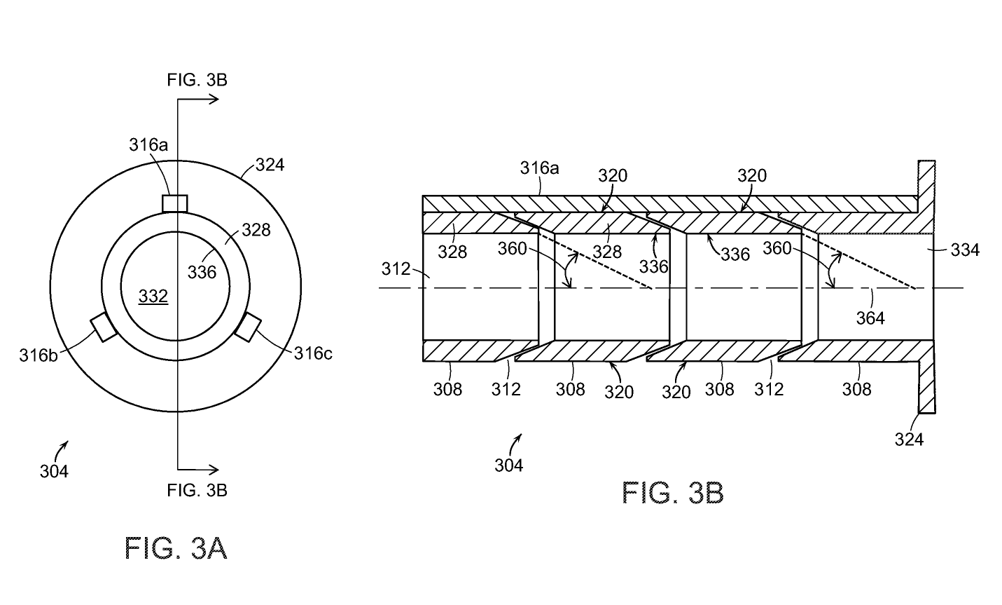

FIGS. 3A and 3B are schematic illustration of two views of a conduit 304 of a plasma chamber, according to an illustrative embodiment of the invention. The conduit 304 could be used as the first conduit 104 of FIG. 1. FIG. 3A is an end view of the conduit 304. FIG. 3B is a cross-sectional side view of the conduit 304. The conduit 304 includes a wall, 328, an inlet 332, an outlet 334 and an inner surface 336. The conduit 304 includes a plurality of conduit sections 308. The conduit sections 308 are coupled together to define a plurality of openings 312 located between adjacent conduit sections 308. Passageways defining the openings 312 are located at an acute angle 360 relative to a longitudinal axis 364 of the conduit 304. The passageways defining the openings 312 are directed radially inward in the conduit 304. In some embodiments, the passageways defining the openings are also directed partially tangentially in the conduit 304 (i.e., not directed towards the center of the conduit 304. The conduit sections 308 are coupled together with three ribs 316a, 316b, and 316c (generally 316). The ribs 316 join the outer surfaces 320 of each of the conduit sections 308.

In one embodiment, the conduit 304 is used with a second conduit (not shown) to create a plasma chamber (e.g., second conduit 108 of plasma chamber 100 of FIG. 1). The conduit 304 is disposed in the second conduit defining a channel between the outer surfaces 320 of the conduit sections 308 and an inner surface of the second conduit. The ribs 316 define the channel gap size between the outer surfaces 320 of the conduit sections 308 and the inner surface of the second conduit.

Alternative structures or components can be used in alternative embodiments to couple together the conduit sections 308. For example, in some embodiments, one or more ribs are used to couple together the conduit sections 308. In some embodiments, ribs or coupling elements are used inside the conduit 304 to couple together the conduit sections.

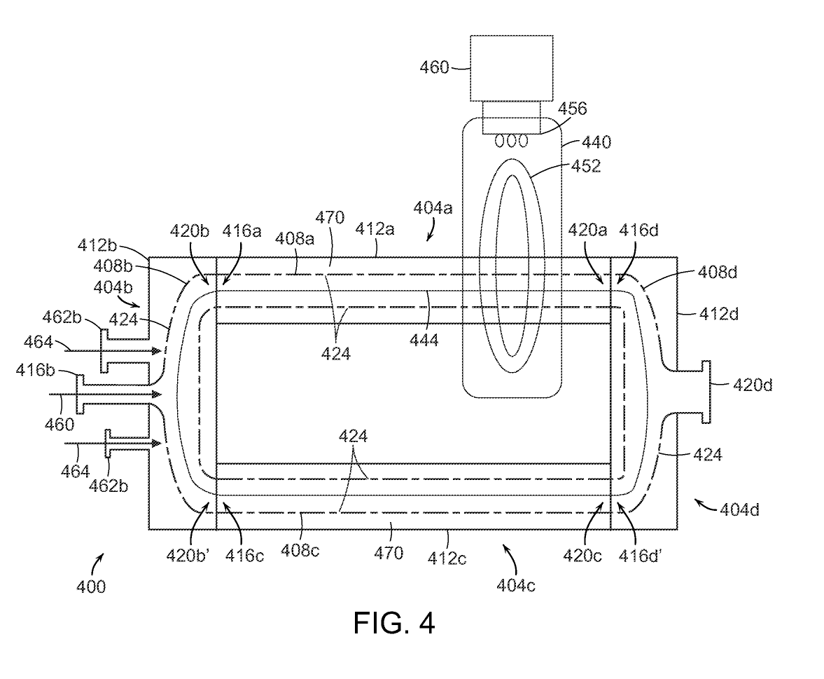

FIG. 4 is a schematic illustration of a toroidal plasma chamber 400, according to an illustrative embodiment of the invention. The chamber 400 includes four conduit legs 404a, 404b, 404c, and 404d (generally 404) coupled together to form the toroidal plasma chamber 400. Conduit leg 404a has an inner, first conduit 408a (e.g., first conduit 104 of FIG. 1) and an outer, second conduit 412a (e.g., second conduit 108 of FIG. 1). Conduit leg 404a also includes an inlet 416a and an outlet 420a. Conduit leg 404c has an inner, first conduit 408c (e.g., first conduit 104 of FIG. 1) and an outer, second conduit 412c (e.g., second conduit 108 of FIG. 1). Conduit leg 404c also includes an inlet 416c and an outlet 420c.

Conduit leg 404b has an inner, first conduit 408b and an outer, second conduit 412b. Conduit leg 404b has inlets 416b and 462b and two outlets 420b and 420b′. Conduit leg 404d has an inner, first conduit 408d and an outer, second conduit 412d. Conduit leg 404d has two inlets 416d and 416d′ and one outlet 420d. Conduits 408a, 408b, 408c, and 408d (generally 408) have a plurality of passages 424 through the walls of the conduits 408 defining a plurality of openings (e.g., slits or holes) through the walls.

The conduit legs 404 are configured so outlet 420b′ of conduit leg 404b is coupled to inlet 416c of conduit leg 404c. Outlet 420c of conduit leg 404c is coupled to inlet 416d′ of conduit leg 404d. Outlet 420b of conduit leg 404b is coupled to inlet 416a of conduit leg 404a. Outlet 420a of conduit leg 404a is coupled to inlet 416d of conduit leg 404d.

In operation, a first gas 460 is provided to the inlet 416b of the conduit leg 404b and flows through each of the conduits 404. The first gas 460 is used to generate a reactive gas in the conduits 404 with a toroidal plasma 444 that is formed in the conduits 404. The system includes a power transformer 440 that couples electromagnetic energy into the plasma 444. The power transformer 440 includes a high permeability magnetic core 452, a primary coil/winding 456, and the plasma chamber 400. The plasma chamber 400 allows the plasma 444 to form a secondary circuit of the transformer 440. The system also includes a power supply 460 (e.g., a switching power supply). In one embodiment, the power supply 460 includes a voltage supply directly coupled to a switching circuit containing a switching semiconductor device. The voltage supply can be a line voltage supply or a bus voltage supply. The switching semiconductor device can be a set of switching transistors. The switching circuit can be a solid state switching circuit. An output of the circuit can be directly coupled to the primary winding 456 of the transformer 440.

In operation, a second gas 464 is provided to the inlet 462b of the conduit leg 404b. The second gas 464 flows along a channel 470 defined between first conduits 408 and second conduits 412. The second gas 464 flows along the channel 470 and through the openings of the passages 428 into the first conduit 408. The second gas 464 surrounds the reactive gas and plasma 444 in the first conduits 408. The second gas 464 can be an inert gas, a process gas, or a mixture of an inert gas and a process gas. The second gas 464 can be the same as the first gas 460.

In operation, properties (e.g., gas flow rate, species mix, pressure) of the second gas 464 are controlled so gas flowing along the channel 470 and then through the openings into the first conduits 408 create a pressure gradient that forces the reactive gas and plasma 444 away from the inner surfaces of the first conduits 408.

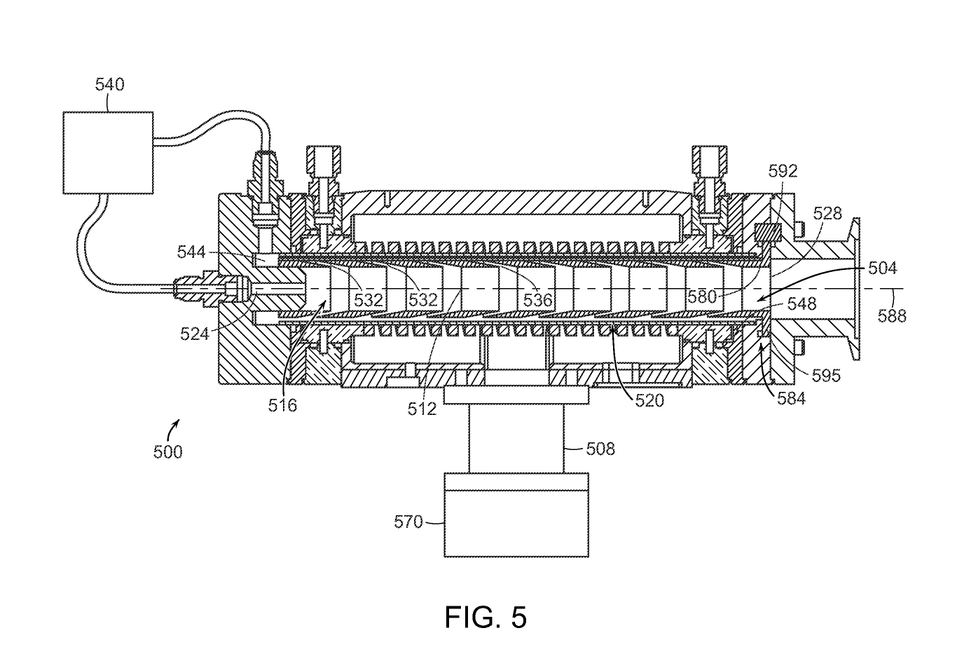

FIG. 5 is a cross-sectional view of a microwave plasma applicator 500, according to an illustrative embodiment of the invention. The applicator 500 includes a dielectric plasma chamber 504 (e.g., plasma chamber 100 of FIG. 1) made of a material (e.g., quartz, sapphire, alumina, aluminum nitride, boron nitride, yttria, or other suitable dielectrics) that is substantially transparent to microwave energy. The applicator 500 also includes a waveguide 508. The waveguide 508 carries microwave energy from a power source 570 (a microwave power source in this embodiment) to the inside 512 of the plasma chamber 504 (e.g., in the conduit 104 of FIG. 1) to create and sustain a plasma in the plasma chamber 504.

The plasma chamber 504 includes a first conduit 516. The first conduit 516 has an inlet 524 and an outlet 528. The first conduit 516 also has a plurality of passages 532 through the wall of the conduit 516 defining a plurality of openings 536 through the wall. The applicator includes a gas supply 540 for supplying a first and second gas to the plasma chamber 504. In operation, the first gas is provided to the inlet 524 of the first conduit 516 to generate a reactive gas in the first conduit 516 with a plasma that is formed in the first conduit 516. The second conduit 520 has an inlet 544 and an outlet 548. The first conduit 516 is disposed in the second conduit 520 (similarly as described with respect to plasma chamber 100 of FIG. 1), defining a channel (not shown for clarity of illustration purposes) between the outer surface of the first conduit 516 and the inner surface of the second conduit 520. In operation, a second gas is provided to the inlet 544 of the second conduit 520 by the gas supply 540. The second gas flows along the channel and through the openings 536 of the passages 532 into the first conduit 516. The second gas surrounds the reactive gas and plasma in the first conduit 516 similarly as described herein. The first gas and the second gas may also be supplied by the same gas source.

The outlet 528 of the first conduit 516 has a mounting flange 580 for coupling one common end 584 of the first and second conduits 516 and 520 to the plasma applicator 500 (e.g., reactive gas source). By coupling the first and second conduits 516 and 520 at one common end 584 (and not elsewhere), thermo-mechanical stress is reduced in the first and second conduits 516 and 520 because the first conduit 516 is free to expand and contract along a longitudinal axis 588 of the applicator 500. The mounting flange 580 can also form a gas seal 595 so as to seal off the outlet 548 of the second conduit 520. By sealing off the outlet 548 of the second conduit 520, all of the second gas is forced to flow through the openings 536 of the passages 532 into the first conduit 516.

The applicator 500 also includes a registration element 592 that insures appropriate first and second conduits 516 and 520 are used with the applicator 500. In this embodiment, the registration element 592 is part of the mounting flange 580. The registration element 592 registers with a corresponding location on the applicator 500 to, for example, enable a processor (not shown, but coupled to the applicator 500) to authorize operation of the applicator 500. The registration element 592 can be, for example, a conducting layer on the mounting flange 580 that closes an electrical connection for registration or a mechanical protrusion that closes a mating mechanical switch for registration.

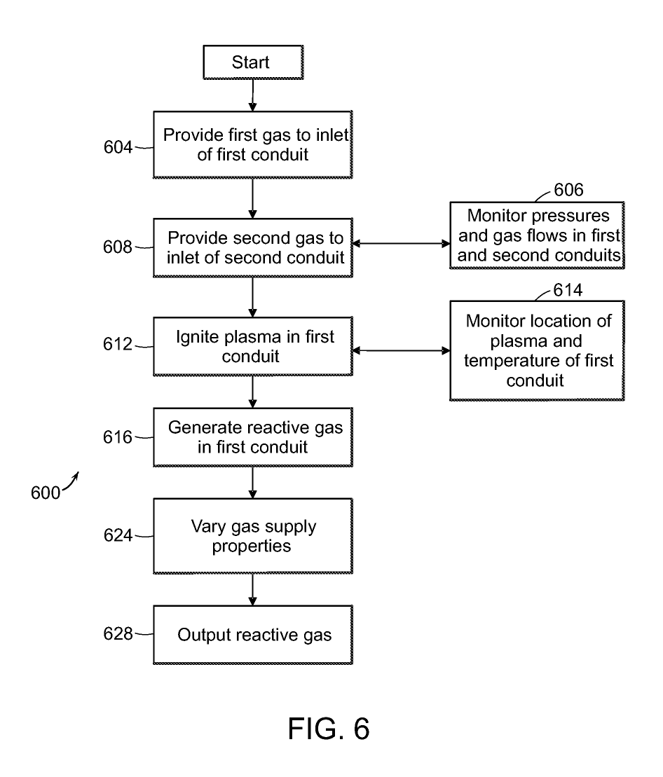

FIG. 6 is a flowchart 600 of a method for generating a reactive gas in a plasma chamber of a reactive gas source, according to an illustrative embodiment of the invention. The plasma chamber can be, for example, the plasma chamber 100 of FIG. 1. In one embodiment, the plasma chamber includes a first conduit that includes a wall, an inlet, an outlet, an inner and outer surface, and a plurality of openings through the wall. The plasma chamber also includes a second conduit that includes a wall, an inlet, an outlet, and an inner surface. The first conduit is disposed in the second conduit defining a channel between the outer surface of the first conduit and the inner surface of the second conduit.

The method includes providing 604 a first gas to the inlet of a first conduit. The method also includes igniting 612 a plasma in the first conduit by applying electromagnetic energy in the first conduit (e.g., with a power source, for example, a microwave source). The method also includes generating 616 a reactive gas in the first conduit with the plasma formed in the first conduit. The method also includes providing 608 a second gas to the inlet of the second conduit. The second gas flows along the channel (defined by the first and second conduit) and through the plurality of openings of the wall of the first conduit into the first conduit. The second gas surrounds the reactive gas and plasma in the first conduit. The method also includes outputting 628 the reactive gas generated in the plasma chamber to a processing chamber (e.g., wafer processing chamber).

In some embodiments, the method includes providing 608 the second gas to the inlet of the second conduit prior to providing the first gas to the inlet of the first conduit. By providing 608 the second gas prior to providing the first gas and igniting the plasma, the second gas (e.g., second gas 156 of FIG. 1) creates a sheath of the second gas that prevents the first gas, reactive gases, and plasma from impinging on the inner surface of the first conduit (e.g., inner surface 118 of the first conduit 104 of FIG. 1) during ignition. In some embodiments, the method includes simultaneously providing the first and second gases to the inlets of the respective first and second conduits.

The method includes monitoring 606 the gas pressures in the first conduit and in the channel between the first conduit and the second conduit. A pressure gradient across the first conduit is needed for the second gas to flow through the openings in the first conduit to force the reactive gas and plasma away from the inner surface of the first conduit. A pressure gradient also helps to generate and sustain a plasma inside the first conduit, and not in the channel between the first conduit and the second conduit. The method includes monitoring the flow rates 606 of the first gas (provided in step 604) and the second gas (in step 608). The gas flow rates can be measured directly with, for example, mass flow meters. Alternatively, the flow rates can also be monitored by measuring the gas pressures in the first conduit and in the channel between the first and the second conduits.

The method also includes monitoring 614 the location of the plasma and the temperature of the first conduit. Normally, the plasma is formed inside the first conduit and kept away from the surface of the first conduit. Under abnormal conditions (e.g., such as when the flow rate of the second gas is insufficient) plasma may reach the surface of the first conduit or even be in the channel between the first and the second conduits. Once an abnormal condition occurs, operation parameters such as gas flow rates, plasma power and matching circuit electrical properties are adjusted to correct the condition. For example, the flow rate of the second gas may be increased to create a larger pressure gradient to force the plasma away from the walls of the conduit. In addition, plasma power may be reduced by lowering the energy provided to the gas source to decrease the thermal load on the conduit walls. Electrical properties (e.g., matching capacitor, resistor and inductor values) of matching circuits used in the gas source may be varied to more closely match the properties of the power supply to the electrical properties of the plasma to decrease the thermal load on the conduit walls. If the abnormal condition cannot be corrected, the operation may be terminated. Optical probes can be used, for example, to monitor the location of the plasma relative to the walls of the conduit. In some embodiments, a thermocouple is attached to the first conduit to monitor the temperature of the conduits. Operation parameters can be adjusted based on the location of the plasma relative to the walls of the conduit.

The method also includes varying 624 gas supply properties of the second gas. Properties (e.g., gas flow rate and pressure) of the second gas are controlled so gas flowing along the channel and then through the openings into the first conduit create a pressure gradient that forces the reactive gas and plasma away from the inner surface of the first conduit. The flux of energetic charged particles on the surfaces (e.g., inner surface) of the first conduit is reduced by forcing the reactive gas and plasma away from the inner surface of the first conduit. The gas flow and pressure gradient also push the neutral gases excited by the plasma away from the inner surface of the first conduit. This reduces surface erosion of the first conduit and the associated chemical or particle contamination that otherwise occurs. The gas flowing through the openings of the wall of the first conduit also provides cooling to the wall. The wall of the first conduit is cooled because heat flux from the plasma to the wall is reduced when the plasma is forced away from the inner surface of the wall. In addition, the first conduit is also cooled by the heat convection effects associated with the second gas flowing through the openings and along the inner surface and outer surface of the first conduit. In some embodiments, gas supply properties of the second gas are varied (step 624) to create or modify the properties of a sheath of gas surrounding the plasma and reactive gas formed in the first conduit. In some embodiments, gas supply properties of the second gas are varied (step 624) to cool the wall of the first conduit.

An exemplary embodiment of the invention is illustrated in FIG. 5, which is a cross-sectional view of a microwave plasma applicator 500. The applicator 500 includes a first conduit 516 that forms the plasma chamber 504, and includes a second conduit 520. Both conduits are made of dielectric materials that are transparent to microwave power flux. The applicator 500 also includes a waveguide 508 that carries microwave energy from a microwave power source 570 to the inside 512 of the plasma chamber 504 to create and sustain a plasma in the plasma chamber 504. One exemplary construction of the applicator 500 includes openings 536 in the first conduit 516 that are 8 annular gaps that are 0.02 cm wide, and angled at 10 degrees relative to the flow direction of the main process gas along the longitudinal axis 588 of the first conduit 116. Oxygen and nitrogen plasmas are generated in the plasma chamber 504 by exciting the inlet gases with microwave power. When 4 SLM (Standard Liters per Minute) of gas is flowing through the channel between the first conduit and the second conduit, the pressure surrounding the first conduit is above 10 Torrs. The pressure inside the first conduit is maintained at 1 to 3 Torrs. In one experiment, plasmas were generated at microwave power levels of 1 to 5 kW. The pressure gradient and the gas flow through the openings in the first conduit force the reactive gas and plasma away from the inner surface of the first conduit, reducing surface plasma interactions and the corresponding erosion of the plasma chamber wall and chemical and particle contaminations to the process.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A plasma chamber for use with a reactive gas source, comprising:
a first conduit comprising a wall, an inlet, an outlet, an inner and outer surface, and a plurality of openings through the wall, the inlet for receiving a first gas for generating a reactive gas in the first conduit with a plasma formed in the first conduit; and
a second conduit comprising a wall, an inlet, and an inner surface;
wherein the first conduit is disposed in the second conduit defining a channel between the outer surface of the first conduit and the inner surface of the second conduit, wherein a second gas provided to the inlet of the second conduit flows along the channel and through the plurality of openings of the wall of the first conduit into the first conduit to surround the reactive gas and plasma in the first conduit.

2. The plasma chamber of claim 1, wherein the openings are directed radially inward through the wall of the first conduit.

3. The plasma chamber of claim 2, wherein the openings are directed radially inward through the wall of the first conduit and along the first gas flow direction.

4. The plasma chamber of claim 2, wherein the openings are directed radially inward through the wall of the first conduit and with an acute angle relative to the first gas flow direction.

5. The plasma chamber of claim 1, wherein the first conduit comprises a plurality of conduit sections coupled together and the openings are located between the conduit sections where they are coupled together.

6. The plasma chamber of claim 5, wherein the plurality of conduit sections are coupled together with one or more ribs joining the outer surfaces of each conduit section to each other.

7. The plasma chamber of claim 6, wherein the one or more ribs define the channel gap between the outer surface of the first conduit and the inner surface of the second conduit.

8. The plasma chamber of claim 1, comprising a power source for generating the plasma in the first conduit.

9. The plasma chamber of claim 1, wherein the first gas type is the same as the second gas type.

10. The plasma chamber of claim 1, wherein the openings are holes, slots, slits or a combination thereof

11. The plasma chamber of claim 1, wherein the second conduit has an outlet.

12. The plasma chamber of claim 1, wherein the second conduit does not have an outlet.

13. The plasma chamber of claim 1, wherein the outlet of the first conduit comprises a mounting flange for coupling one common end of the first and second conduits to the reactive gas source, wherein by coupling the one common end of the first and second conduits thermal mechanical stress is minimized in the first and second conduits in operation.

14. The plasma chamber of claim 11, wherein the outlet of the second conduit is sealed off, wherein by sealing off the outlet of the second conduit all of the gas entering the second conduit flows through the plurality of openings in the wall of the first conduit into the first conduit.

15. The plasma chamber of claim 1, wherein the first and second conduits each comprise a plurality of conduit legs forming a toroidal plasma chamber.

16. A method for generating a reactive gas in a plasma chamber of a reactive gas source, the plasma chamber comprising a first conduit comprising a wall, an inlet, an outlet, an inner and outer surface, and a plurality of openings through the wall, and comprising a second conduit comprising a wall, an inlet, and an inner surface, wherein the first conduit is disposed in the second conduit defining a channel between the outer surface of the first conduit and the inner surface of the second conduit, the method comprising:
providing a first gas to the inlet of the first conduit;
generating a reactive gas in the first conduit with a plasma formed in the first conduit; and
providing a second gas to the inlet of the second conduit that flows along the channel and through the plurality of openings of the wall of the first conduit into the first conduit to surround the reactive gas and plasma in the first conduit.

17. The method of claim 16, comprising providing the second gas to the inlet of the second conduit prior to providing the first gas to the inlet of the first conduit.

18. The method of claim 16, comprising simultaneously providing the first and second gases.

19. The method of claim 16, comprising varying gas supply properties of the second gas to create a sheath of gas surrounding the plasma and reactive gas formed in the first conduit.

20. The method of claim 19, comprising varying the gas supply properties to cool the wall of the first conduit.

21. The method of claim 19, comprising igniting the plasma in the first conduit by applying electromagnetic energy in the first conduit.

22. The method of claim 19, wherein the second gas flows radially inward in the first conduit.

23. The method of claim 16, comprising monitoring the gas pressures and flow rates in the first conduit and in the channel between the first conduit and the second conduit.

24. The method of claim 16, comprising monitoring the position of the plasma relative to the first conduit and the temperature of the first conduit.

25. The method of claim 16, wherein the second conduit includes an outlet, the method comprising sealing off the outet of the second conduit to cause the gas entering the second conduit to flow through the plurality of openings in the wall of the first conduit into the first conduit.

26. A reactive gas source, comprising:
a plasma chamber comprising:
a first conduit comprising a wall, an inlet, an outlet, an inner and outer surface, and a plurality of openings through the wall, the inlet for receiving a first gas for generating a reactive gas in the first conduit with a plasma formed in the first conduit; and
a second conduit comprising a wall, an inlet, and an inner surface;
wherein the first conduit is disposed in the second conduit defining a channel between the outer surface of the first conduit and the inner surface of the second conduit, wherein a second gas provided to the inlet of the second conduit flows along the channel and through the plurality of openings of the wall of the first conduit into the first conduit to surround the reactive gas and plasma in the first conduit; and
a power source for generating the plasma in the first conduit with the first gas; and
a gas supply for supplying the first and second gas to the plasma chamber.

27. A conduit for a plasma chamber for use with a reactive gas source, the conduit comprising:
a wall;
an inlet;
an outlet;
an inner and outer surface; and
a plurality of openings through the wall, the plurality of openings for receiving a gas to surround a reactive gas and plasma formed in the conduit.

28. The conduit of claim 27, comprising a registration element that registers with a corresponding element on a reactive gas source.
